(19) United States
(12) Patent Application Publication
(10) Pub. No.: US 2020/0060365 A1
(43) Pub. Date: Feb. 27, 2020

(54) WATERPROOF AND BREATHABLE SEA FISHING TROUSERS HAVING A TITANIUM ALLOY HEAT INSULATION LAYER

(71) Applicant: PACIFIC EAGLE ENTERPRISE CO., LTD., Taichung City (TW)

(72) Inventor: James SHIH, Taichung City (TW)

(21) Appl. No.: 16/109,725

(22) Filed: Aug. 22, 2018

(51) Int. Cl. A41D 31/02; A41D 1/08; A41D 13/012; B32B 5/02; B32B 5/16

(52) U.S. Cl. CPC A41D 31/02; A41D 1/08; A41D 13/012; B32B 5/028; B32B 5/16; B32B 2307/724; A41D 2600/106; B32B 2264/105; B32B 2437/00; B32B 2307/7265; A41D 2400/22

(57) ABSTRACT

A pair of waterproof and breathable sea fishing trousers having a titanium alloy heat insulation layer essentially includes: an outer layer, a breathable membrane layer, a titanium alloy heat insulation layer, and an inner layer. The titanium alloy heat insulation layer is made of titanium alloy, tin, or aluminum alloy rubber, disposed between the breathable membrane layer and the inner layer, and can reflect body heat of the user. The user's body heat is accumulated in the inner layer and is released again to the user's body to keep the user warm, thereby avoiding the fisherman's temperature loss. Besides, the pair of fishing trousers is breathable and waterproof, making the fisherman feel comfortable to wear.

### BACKGROUND

### Field of the Invention

The present invention relates to a pair of sea fishing trousers, and more particularly to a waterproof and breathable sea fishing trousers having a pair of titanium alloy heat insulation layer waterproof.

### Related Prior Art

Please refer to FIG. 1A to FIG. 1B for a perspective view and a cross-sectional view of a pair of conventional fishing trousers. The sea fishing trousers 10 includes: an inner lining layer 11 attached to the human skin, a breathable layer 12 disposed on the inner lining layer 11, and an outer coating layer 13 disposed on the breathable layer 12, wherein the breathable layer 12 has a plurality of through micro pores 121, so as to form a pair of breathable but waterproof sea fishing trousers.

However, when fishing in the water or hunting fish in the swamp, most of the angler's body is soaked in the water, so the fishing pants must be waterproofing and are usually made of plastic material (PU) to provide waterproof and breathable functions. Due to the breathability, the sea fishing trousers cannot provide the function of keeping warmth and preventing cold, therefore, the function of the fishing trousers is slightly insufficient, and there is still room for improvement. If the angler stays in the water for a long time, the hypothermia may occur, this may even endanger the safety of the angler.

The present invention has arisen to mitigate and/or obviate the afore-described disadvantages.

### SUMMARY

One objective of the present invention is to provide a pair of waterproof and breathable sea fishing trousers having a titanium alloy heat insulation layer, which mainly provides heat preservation effect to prevent the fisherman's temperature loss and having both breathable and waterproof effects.

To achieve the above objective, a pair of waterproof and breathable sea fishing trousers having a titanium alloy heat insulation layer in accordance with the present invention, comprises:

an outer layer with an outer-layer surface;

a breathable membrane layer disposed on the outer layer, and including: a first breathable-membrane surface disposed on the outer-layer surface, and a second breathable-membrane surface opposite to the first breathable-membrane surface;

the titanium alloy heat insulation layer disposed on the breathable membrane layer, capable of reflecting body heat, and composed of a plurality of heat reflecting particles, wherein the plurality of heat reflecting particles form a first heat insulation surface disposed on the second breathable-membrane surface, and a second heat insulation surface opposite to the first heat insulation surface; and

an inner layer coining into contact with a user's skin, and disposed on the second heat insulation surface of the titanium alloy heat insulation layer.

Preferably, the inner layer is netlike and has a plurality of mesh holes, the breathable membrane layer has a plurality of micro pores penetrating through the first and second breathable-membrane surfaces, and each of the heat reflecting particles has a diameter larger than a diameter of each of the micro pores and the mesh holes.

Preferably, the titanium alloy heat insulation layer is made of titanium alloy, tin or aluminum alloy rubber.

Accordingly, the present invention provides a pair of waterproof and breathable sea fishing trousers having a titanium alloy heat insulation layer, which essentially comprises: the outer layer, the breathable membrane layer, the titanium alloy heat insulation layer, and the inner layer. The titanium alloy heat insulation layer is made of titanium alloy, tin, or aluminum alloy rubber, disposed between the breathable membrane layer and the inner layer, and can reflect body heat of the user. The user's body heat is accumulated in the inner layer and is released again to the user's body to keep the user warm, thereby avoiding the fisherman's temperature loss. Besides, the pair of fishing trousers is breathable and waterproof, making the fisherman feel comfortable to wear.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

FIG. 1A is a perspective view of a pair of conventional fishing trousers;

FIG. 1B is a cross sectional view of FIG. 1A;

FIG. 2 is an exploded view of a pair of waterproof and breathable sea fishing trousers having a titanium alloy heat insulation layer in accordance with a preferred embodiment of the invention; and

FIG. 3 is a cross sectional view of the pair of waterproof and breathable sea fishing trousers in accordance with the present invention.

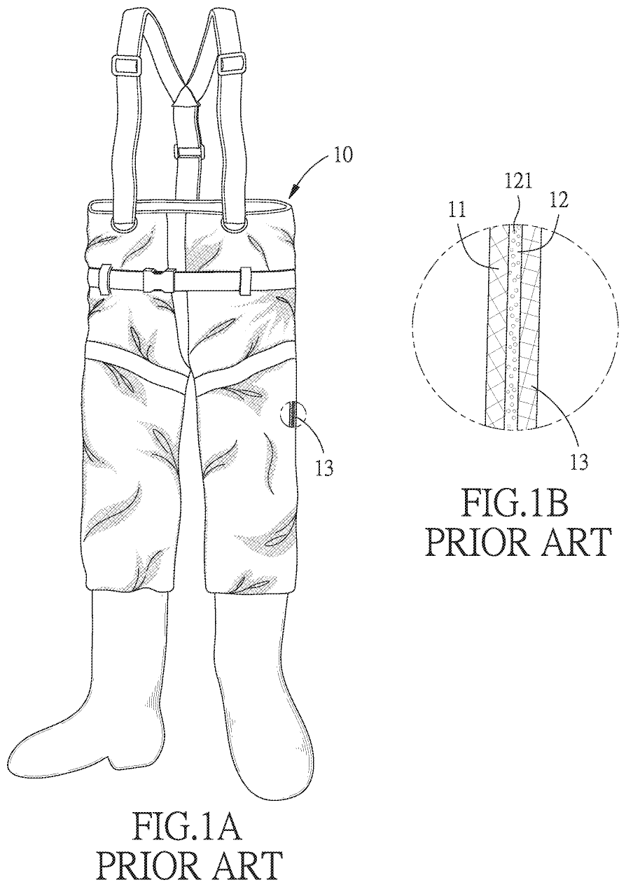

### DETAILED DESCRIPTION

The present invention will be clearer from the following description when viewed together with the accompanying drawings, which show, for purpose of illustrations only, the preferred embodiment in accordance with the present invention.

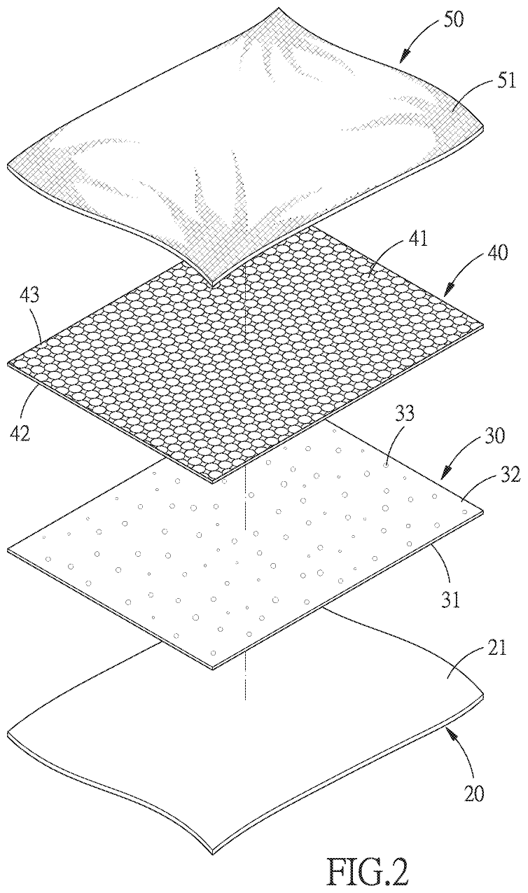

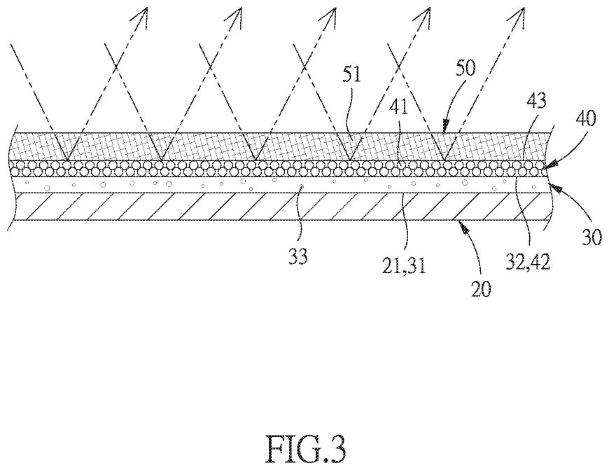

Referring to FIGS. 2-3, the pair of waterproof and breathable sea fishing trousers having a titanium alloy heat insulation layer 40 in accordance with a preferred embodiment of the invention essentially comprises: an outer layer 20, a breathable membrane layer 30, the titanium alloy heat insulation layer 40, and an inner layer 50.

The outer layer 20 faces the outside, includes an outer-layer surface 21, and is made of foaming material, such as rubber, but is not limited thereto. The outer cover 20 is made of light weight material, so that the user wearing the finishing trousers of the invention can be more agile and light in fishing activities.

The breathable membrane layer 30 is disposed on the outer layer 20, and includes: a first breathable-membrane surface 31 disposed on the outer-layer surface 21, and an opposite second breathable-membrane surface 32. In this embodiment, the breathable membrane layer 30 is coated on the outer-layer surface 21, and has a plurality of micro pores 33 penetrating through the first and second breathable-membrane surfaces 31, 32 for air circulation. Each of the micro pores 33 has two ends respectively connected to the outer layer 20 and the titanium alloy heat insulation layer 40. The diameter of each of the micro pores 33 is smaller than the diameter of the liquid molecules, and is larger than the diameter of the gaseous molecules. Therefore, the micro pores 33 are breathable but waterproof.

The titanium alloy heat insulation layer 40 is disposed on the breathable membrane layer 30, can reflect body heat, and is composed of a plurality of heat reflecting particles 41. The plurality of heat reflecting particles 41 form a first heat insulation surface 42 disposed on the second breathable-membrane surface 32, and a second heat insulation surface 43 opposite to the first heat insulation surface 42. In this embodiment, the breathable membrane layer 30 is uniformly or unevenly distributed on the titanium alloy heat insulation layer 40 by means of screen printing. The titanium alloy heat insulation layer 40 is made of titanium alloy, tin or aluminum alloy rubber. Therefore, with the titanium alloy heat insulation layer 40, the user can use his/her own energy feedback mechanism to keep warm, and the titanium alloy heat insulation layer 40 can prevent the user's body heat from getting lost and the user won't feel stuffy, and naturally can maintain long-term heat preservation, and can avoid occurrence of hypothermia in the water.

The inner layer 50 is a general cloth, such as a nylon cloth, one side of which is in contact with user's skin, and the other side is disposed on the second heat insulation surface 43 of the titanium alloy heat insulation layer 40. In this embodiment, the inner layer 50 is netlike and has a plurality of mesh holes 51, and the diameter of each of the heat reflecting particles 41 is larger than the diameter of each of the micro pores 33 and each of the mesh holes 51. The inner layer 50 is in contact with the user's skin, and the titanium alloy heat insulation layer 40 can reflect the body heat of the user, and the body heat is accumulated in the inner layer 50 to improve the heat preservation effect. The inner layer 50 is made of a general fabric, which requires no chemical additives to achieve heat insulation, and has excellent skin-friendly properties, providing excellent comfort when worn by a user.

What mentioned above are the structural configurations of the present invention and their connection relations, and the use of the present invention is described as follows:

Accordingly, the present invention provides a pair of waterproof and breathable sea fishing trousers having a titanium alloy heat insulation layer 40, which essentially comprises: the outer layer 20, the breathable membrane layer 30, the titanium alloy heat insulation layer 40, and the inner layer 50. The titanium alloy heat insulation layer 40 is made of titanium alloy, tin, or aluminum alloy rubber, disposed between the breathable membrane layer 30 and the inner layer 50, and can reflect body heat of the user. The user's body heat is accumulated in the inner layer 50 and is released again to the user's body to keep the user warm, thereby avoiding the fisherman's temperature loss. Besides, the pair of fishing trousers is breathable and waterproof, making the fisherman feel comfortable to wear.

While we have shown and described various embodiments in accordance with the present invention, it is clear to those skilled in the art that further embodiments may be made without departing from the scope of the present invention.

What is claimed is:

1. A pair of waterproof and breathable sea fishing trousers having a titanium alloy heat insulation layer, comprising:
an outer layer with an outer-layer surface;
a breathable membrane layer disposed on the outer layer, and including: a first breathable-membrane surface disposed on the outer-layer surface, and a second breathable-membrane surface opposite to the first breathable-membrane surface;
the titanium alloy heat insulation layer disposed on the breathable membrane layer, capable of reflecting body heat, and composed of a plurality of heat reflecting particles, wherein the plurality of heat reflecting particles form a first heat insulation surface disposed on the second breathable-membrane surface, and a second heat insulation surface opposite to the first heat insulation surface; and
an inner layer coining into contact with a user's skin, and disposed on the second heat insulation surface of the titanium alloy heat insulation layer.

2. The pair of waterproof and breathable sea fishing trousers having the titanium alloy heat insulation layer as claimed in claim 1, wherein the inner layer is netlike and has a plurality of mesh holes, the breathable membrane layer has a plurality of micro pores penetrating through the first and second breathable-membrane surfaces, and each of the heat reflecting particles has a diameter larger than a diameter of each of the micro pores and the mesh holes.

3. The pair of waterproof and breathable sea fishing trousers having the titanium alloy heat insulation layer as claimed in claim 1, wherein the titanium alloy heat insulation layer is made of titanium alloy, tin or aluminum alloy rubber.
